(19) United States
(12) Patent Application Publication
(10) Pub. No.: US 2004/0267544 A1
(43) Pub. Date: Dec. 30, 2004

(54) Systems, apparatus, and methods for handling customer requests related to the delivery of items

(76) Inventors: Sharon G Michelson, Bowie, MD (US); Italia D Russell, Houston, TX (US); Romaine R Weiskopf, Houston, TX (US)

Correspondence Address: FINNEGAN, HENDERSON, FARABOW, GARRETT & DUNNER, LLP, 1300 I STREET, NW, WASHINGTON, DC, 20005, US

(21) Appl. No.: 10/363,736

(22) PCT Filed: Aug. 31, 2001
(86) PCT No.: PCT/US01/27012

Related U.S. Application Data
(60) Provisional application No. 60/231,168, filed on Sep. 8, 2000.

(51) Int. Cl. G06F 17/60

(52) U.S. Cl. 705/1; 705/9

(57) ABSTRACT

Systems, apparatus, and methods for handling item delivery information, including customer requests related to the delivery of such items are described. A system for handling a customer request includes means for receiving a customer request from a customer. It further includes means for processing the customer request and means for generating an information sheet, including a code associated with the customer request. Mail delivery personnel may use the information sheet to reduce the error rate associated with the delivery of items and increase their safety. The information sheet may be a sheet of paper, electric paper, or data presented on a liquid crystal display panel.

### RELATED APPLICATIONS

This application claims the benefit of provisional application “Systems, Apparatus, and Methods for Handling Customer Requests Related to Delivery of Items,” filed Sep. 8, 2000, bearing Ser. No. 60/231,168, the contents of which are relied upon and hereby expressly incorporated by reference. United States Provisional Application, entitled Systems and Methods for Providing Change of Address Services Over a Network, Ser. No. 60/198,819, filed Apr. 21, 2000, Attorney Docket No. 08049.6004 was attached to the provisional application Ser. No. 60/231,168, and is also relied upon and hereby expressly incorporated by reference.

### I. BACKGROUND OF THE INVENTION

A. Field of the Invention

The present invention relates to systems, apparatus, and methods for handling customer requests related to delivery of items. More particularly, the invention relates to systems, apparatus, and methods for handling customer requests related to delivery of items, e.g., mail pieces, such as packages, letters, periodicals, newspapers, etc., using an information sheet.

B. Description of the Related Art

The United States Postal Service (USPS) is an independent government agency that provides mail delivery and other services to the public. The USPS delivers mail using a recipient's address on a mailpiece. If an address is incomplete or incorrect, mail delivery is delayed, and the USPS incurs labor and financial costs in forwarding the mailpiece to the correct address. Inaccurate addresses adversely affect the postal customer, the USPS, and the mailing industry.

Approximately forty million postal customers move each year, and each move requires a change in a postal customer's address. Traditionally, a moving postal customer must complete, sign, and submit a change of address form to the USPS. The change of address form cannot be processed until the postal customer signs the form because the signature provides identity validation and authorizes the USPS to forward the customer's mail. Because this process relies on a physical form, it is labor intensive. The customer must sign the form and mail or carry it to a post office. USPS personnel must manually process the form, including data entry of the change of address information.

Also, traditionally, USPS personnel such as mail carriers have relied on stick-on notes or other types of notes to ensure delivery of mail or other items to the right address, to hold mail, or to temporarily forward mail to some other address. These approaches to mail or item delivery are prone to error.

In addition, mail carriers face hazards while delivering mail, such as vicious dogs. Traditionally, once again, mail carriers have relied on stick-on notes or other types of notes to remind themselves of the hazards that they may face at a particular customer's premises. Again, these approaches are prone to error.

Therefore, there is a need for systems, apparatus, and methods, which reduce the error-rate in delivery of items, such as mailpieces, and also reduce the hazards that mail carriers face.

### II. SUMMARY OF THE INVENTION

Systems, apparatus, and methods consistent with the present invention overcome the shortcomings of conventional systems by collecting and processing change of address data, including identity validation, using an electronic network. Furthermore, apparatus consistent with the present invention permits item delivery personnel, such as a mail carrier, to receive customer requests related to item delivery via a computer network and display the same on sheets, including electronic or electric paper.

Exemplary systems, apparatus, and methods consistent with the present invention are recited in the attached claims. It is to be understood that both the foregoing general description and the following detailed description are exemplary and explanatory only and are not restrictive of the invention, as claimed.

In accordance with the principles of the present invention, a method is provided for handling a customer request related to delivery of items using a computer network. The method receives a customer request from a customer, processes the customer request, and generates an information sheet, including a code associated with the customer request.

In accordance with the principles of the present invention, another method is provided for handling information related to delivery of items using a computer network. The method retrieves handling information related to the delivery of an item, and generates an information sheet, including a plurality of codes associated with the handling information.

In accordance with the principles of the present invention, yet another method is provided for reducing error-rates associated with the delivery of items using a computer network. The method generates an information sheet, including at least one code related to one of a plurality of item handling instructions, and uses the code to reduce error-rates associated with the delivery of items.

In accordance with the principles of the present invention, an apparatus is provided for handling information related to delivery of items using a computer network. The apparatus, includes an information sheet comprising several handling information fields. The information fields include information related to changes of address, mail forwarding, holding mail, and safety hazards associated with a particular customer address.

### III. BRIEF DESCRIPTION OF THE DRAWINGS

The accompanying drawings, which are incorporated in and constitute a part of this specification, illustrate embodiments of the invention and, together with the following description, serve to explain the principles of the invention. In the drawings:

FIG. 1 is a block diagram of a system consistent with the present invention;

FIG. 2 is a schematic diagram of an exemplary information sheet consistent with the present invention;

FIG. 3 is an exemplary flow chart of a method for handling a customer request related to the delivery of items using a computer network;

FIG. 4 is another exemplary flow chart of a method for handling a customer request related to the delivery of items using a computer network; and

FIG. 5 is an exemplary flow chart of a method for reducing the error-rate related to the delivery of items consistent with the present invention.

### IV. DETAILED DESCRIPTION

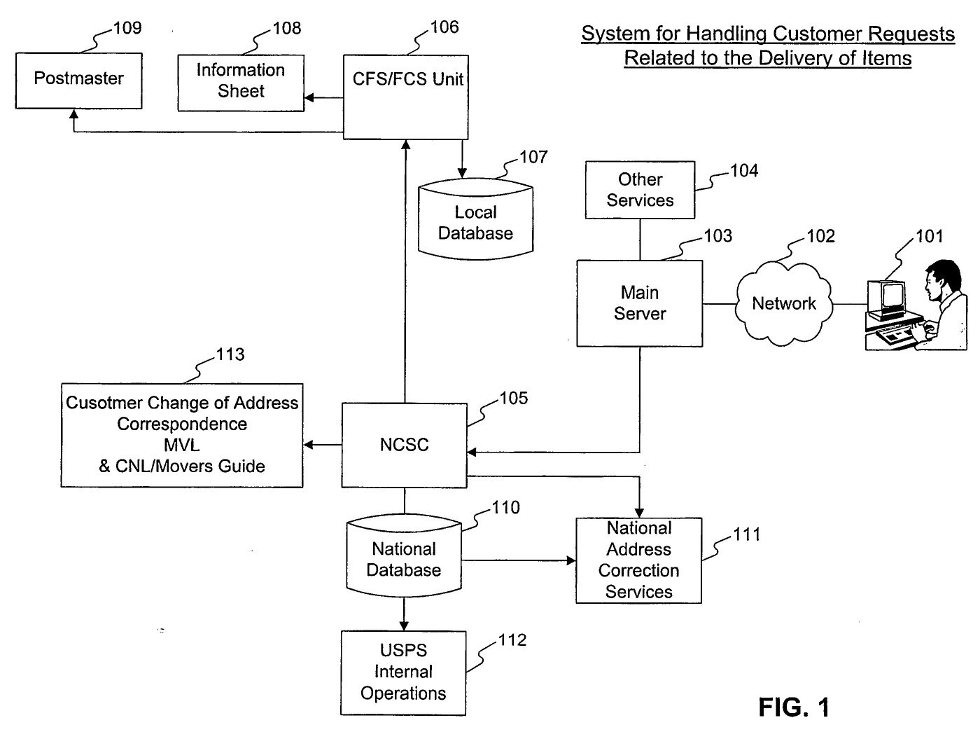

FIG. 1 is a block diagram of an item handling system consistent with an embodiment of the present invention. FIG. 1 depicts a customer 101 who wants to make a request related to handling of his mail or items, such as a change of address. Using a computer, customer 101 accesses a main server 103 via a network 102 and enters his request. Through main server 103, the customer can access other services 104, such as a forward items request, or a hold items request. Main server 103 validates the customer's identity and connects to a central server, for example, a National Customer Support Center (NCSC) 105, where the information is stored in a nationwide database 110. From the NCSC 105, the customer request related information, such as the change of address information, is transmitted throughout the USPS system to change the customer's address and provide other services.

For example, change of address data is automatically downloaded from NCSC 105 to a Computerized Forwarding System/Forwarding Control System (CFS/FCS) unit 106, where forwarding of physical mailpieces and other services is provided. Many other functions are served from NCSC 105 and national database 110, including national address correction services 111, USPS internal operations 112, and customer change of address correspondence 113.

National address correction services 111 are offered by the USPS and USPS commercial licensees to receive an address from a member of the public, e.g., a mailing company, and correct the address, standardize the address, and provide the ZIP+4 coding for the address. USPS internal operations 112 include processing and reporting functions associated with items or mail. Customer change of address correspondence 113 can include a move validation letter (MVL), customer notification letter (CNL), and a USPS Welcome Kit™. Unlike traditional hard copy change of address forms, in one implementation, the present system collects and processes customer requests, for example, change of address information, for these and other services electronically.

Although aspects of the present invention are generally described as being stored in memory, one skilled in the art will appreciate that these aspects may be stored on, or read from, various computer-readable media, such as secondary storage devices, like hard disks, floppy disks, and CD-ROM; a carrier wave received from a network like the Internet; or other forms of ROM or RAM. Additionally, although specific components and programs of the item handling system are depicted in FIG. 1, one skilled in the art will appreciate that these may contain additional or different components or programs.

In addition, besides the customer requests related to the handling of his items, such as mail, item handling information includes other information, for example, any safety hazards, which may be associated with a particular customer's address. Such hazards may include vicious animals, and miscellaneous hazards, such as asbestos.

One skilled in the art will appreciate that even though FIG. 1 depicts a customer 101 entering item handling requests from a terminal connected to a network 102, such requests may be received by other means. For example, a customer may send such requests via regular mail, or a customer may contact a USPS representative via a telephone. In addition, information related to safety hazards may be obtained from item carriers and then inputted into the local database, for example.

Item handling information, including customer requests related to their mail, any additional information corresponding to each request, for example, the change of address information, and other pieces of information are stored in local database 107. One skilled in the art will appreciate that local database 107 may be a collection of distributed databases. In addition, item handling information may be stored and accessed using other information processing programs, such as spreadsheet programs or word-processing programs.

Finally, the item handling information is downloaded to information sheet 108 for presentation to a user, such as a letter carrier. Information sheet 108 may be implemented in several ways, for example, it may be a color print-out from a color printer (not shown) attached to the system of FIG. 1. Information sheet 108 may also be a Liquid Crystal Display (LCD) panel, or another type of display. It may also be implemented as an electric paper sheet. Electric paper sheets are well known in the art, such as for example, the addressable paper display system described in U.S. Pat. No. 5,389,945 to Sheridon the contents of which are hereby expressly incorporated herein by reference. One skilled in the art will appreciate that other technologies may also be used to implement the information sheet including, for example, an Inmedia™ electronic display available from E Ink corporation of Cambridge, Mass.

One skilled in the art will appreciate that relevant information may be downloaded using wireless or wire-based communication systems. Such information could also be transferred to the information sheet using memory devices, such as flash cards or other memory devices. Also, updates to information may be transmitted to the information sheet even when it is being used, for example, by a mail carrier in the field.

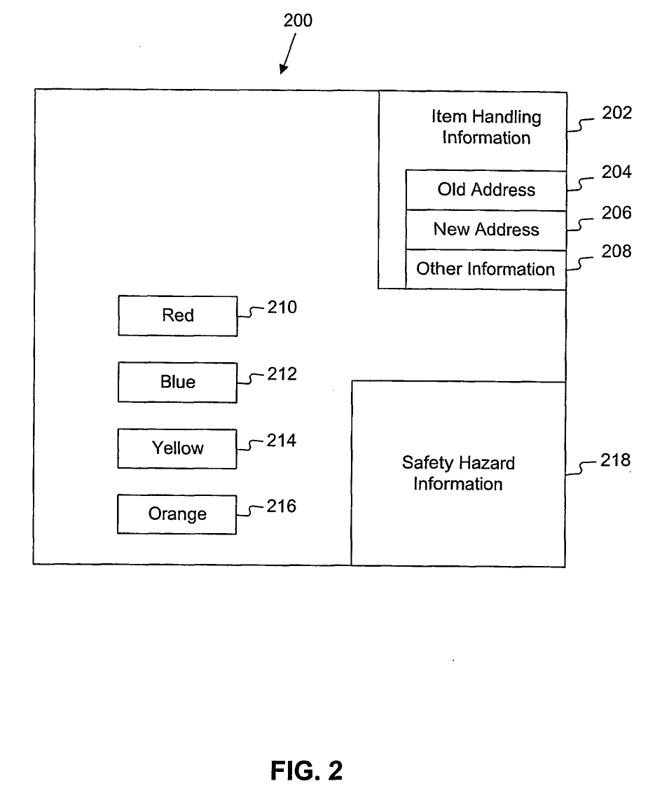

FIG. 2 depicts an exemplary information sheet 200 consistent with the present invention. Information sheet 200 comprises several information fields. These information fields communicate item handling information/instructions to an item carrier, such as a mail carrier. Information fields include item handling information 202; item handling codes 210, 212, 214, and 216; and safety hazard information 218. Item handling information 202 includes old address 204, new address 206, and other information 208. Item handling codes may be color codes or some other codes, which can be recognized by an item carrier. These codes correspond to each one of the types of requests or inputs that an item carrier may consider while handling the delivery of items, such as mail. Item handling code 210, for example, may be red color, indicating a change of address request. In that case, item handling information field 202 will also display the old as well as the new address of the purported recipient of the items at issue. Item handling code 212 may represent a request to hold the items. In this case, other information 208 may display the number of days, for example, for which the items should be held at an item processing center, such as a post office. Item handling code 214 may represent a request to temporarily forward items to another address. In this case, the permanent address and the temporary address may be displayed in old address 204 and new address 206 fields. Other information 208 may display the time period during which the items should be forwarded to the temporary address. One skilled in the art will appreciate that the information fields depicted in FIG. 2 are merely exemplary and additional fields may be added without departing from the scope of the invention.

In one configuration, the information sheet may be laminated or inserted in a plastic sheath. It may also have pockets or sleeves to slide paper cards containing item handling information, for example, a card containing the new address of a customer may be slid into the change of address information field or sleeve. Similarly, the codes associated with each customer request may be colored dots, which may be put on the information sheet.

In another configuration, as discussed above, the information sheet may be an electric paper, where information pertaining to each field and code may be addressed through electrical, electronic, magnetic, or electromagnetic means. Also, in yet another configuration, the information sheet may be a liquid crystal display with addressing means or storage means. In such a case, the information pertaining to each field and code may be addressed using conventional LCD addressing mechanisms.

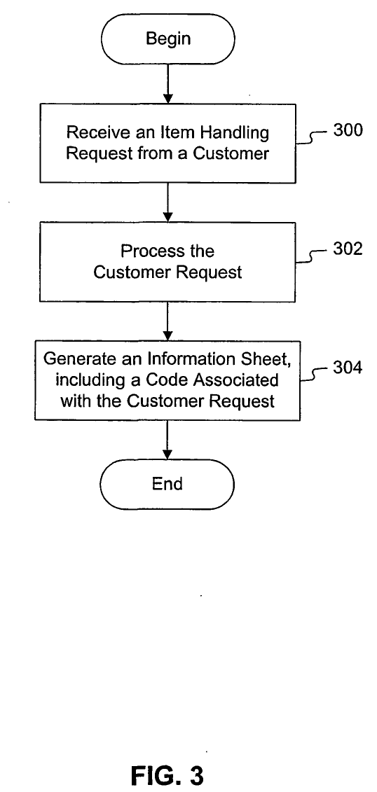

FIG. 3 depicts an exemplary flow chart of a process for handling a customer request related to the delivery of items using a computer network. In stage 300 the system receives an item handling request from a customer. In stage 302, the system processes the customer request. In stage 304, the system generates an information sheet, including a code associated with the customer request.

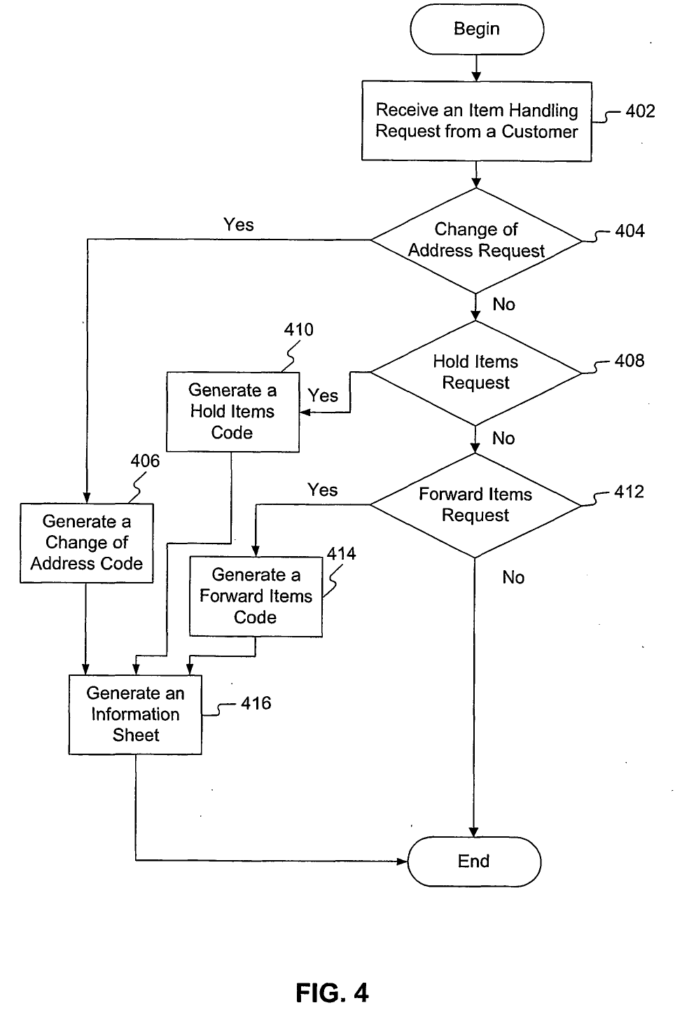

FIG. 4 depicts an exemplary flow chart for processing an item handling request from a customer. The first step (stage 402) is performed when the item handling system receives an item handling request from a customer. The item handling system then determines whether it is a change of address request (stage 404). If it is a change of address request, then a code corresponding to a change of address is generated in stage 406. If it is not a change of address request, then the processing continues to the next step. The item handling system then determines whether the customer request is a hold items request (stage 408). If it is a hold items request then the system generates a hold items code (stage 410). If it is not, then the system determines whether it is a forward items request (stage 412). If it is, then the system generates a forward items code (stage 414). If it is not a forward items request, then the processing ends. If, however, the customer makes any of the item handling requests, then in stage 416, the system generates an information sheet.

One skilled in the art will appreciate that the steps involved in processing customer requests may be performed in a different order. In addition, the steps illustrated are merely exemplary and other types of item handling requests may also be processed. Also, the final step involving the generation of the information sheet may involve transferring the respective code to the information sheet. Finally, even though FIG. 4 does not depict adding safety hazard and other information to the information sheet, such information may be added during stage 416. This information may be derived from local database 107, shown in FIG. 1, or it may be inputted to the item handling system during processing of the item handling request.

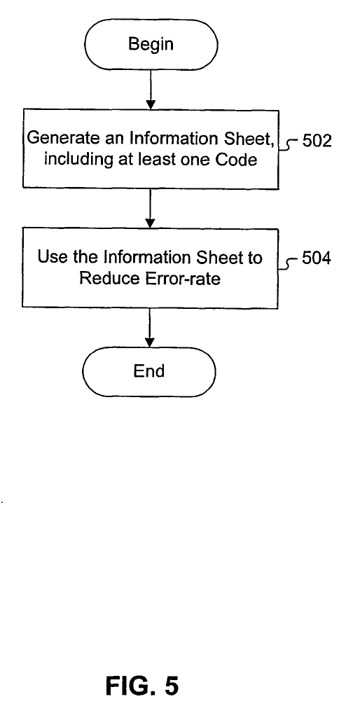

FIG. 5 is an exemplary flow chart of a process for reducing the error-rate related to the delivery of items consistent with the present invention. The first step involves generating an information sheet, including at least one code associated with an item handling request (stage 502). The next step (stage 504) involves using the information sheet to reduce error-rate and improve the well being of item delivery personnel, such as mail carriers. This step may involve placing the information sheet next to the items destined for the customer, to whose address the information sheet pertains to. An item delivery person, such as a mail carrier, may then while delivering mail, for example, be reminded of the item handling requests or other item handling information, such as safety hazards. Thus, the use of the information sheet helps reduce error rates in delivery of items and also results in better working conditions for the delivery personnel.

One skilled in the art will appreciate that the systems, apparatus, and methods disclosed herein are merely exemplary, for example, other codes may be added to the information sheet without departing from the scope of the invention.

What is claimed is:

1. A method for handling a customer request related to delivery of items, the method comprising:
receiving an item handling request from a customer;
processing the item handling request; and
generating an information sheet, including a code associated with the item handling request.

2. The method of claim 1, wherein the information sheet is a sheet of printable media.

3. The method of claim 1, wherein the information sheet is an electrically writeable medium.

4. The method of claim 1, wherein the information sheet is presented on a display panel.

5. The method of claim 4, wherein the display panel is a liquid crystal type.

6. The method of claim 1, wherein the code is a change of address code.

7. The method of claim 1, wherein the code is a hold items code.

8. The method of claim 1, wherein the code is a forward items code.

9. The method of claim 1, wherein the information sheet contains the customer's old address.

10. The method of claim 1, wherein the information sheet contains the customer's new address.

11. The method of claim 1, wherein the information sheet contains information concerning the duration for which the customer's items be held.

12. The method of claim 1, wherein the information sheet contains information concerning hazard-related data for delivery personnel.

13. A method for handling a customer request related to delivery of items, the method comprising:
receiving an item handling request from a customer;
processing the item handling request; and
generating an information sheet, including at least one code associated with the item handling request, wherein the code may be a change of address code, a hold items code, or a forward items code.

14. A method for reducing errors associated with the delivery of items, the method comprising:
generating an information sheet, including at least one code related to one of a plurality of item handling instructions; and
using the code to reduce errors associated with the delivery of items.

15. A method for assisting mail delivery personnel, the method comprising:
generating an information sheet, including at least one code related to one of a plurality of item handling instructions and at least one code related to safety hazards on a route traveled by mail delivery personnel; and
using the code to reduce an error-rate associated with the delivery of mail, and to increase safety of mail delivery personnel.

16. A method in a computer network for reducing error-rate associated with the delivery of items, the method comprising:
retrieving information from the computer network, including at least one code related to one of a plurality of item handling instructions, and at least one code related to safety hazards on a route related to the delivery of items;
generating an information sheet, including the code related to the item handling instructions and the code related to safety hazards; and
using the code to reduce an error-rate associated with the delivery of items and to increase safety of the personnel delivering the items.

17. A system for handling a customer request related to delivery of items, the system comprising:
means for receiving an item handling request from a customer;
means for processing the item handling request; and
means for generating an information sheet, including a code associated with the item handling request.

18. The system of claim 17, wherein the information sheet is an electrically writable medium.

19. The system of claim 17, wherein the information sheet is an electrically writable medium.

20. The system of claim 17, wherein the information sheet is presented on a liquid crystal display panel.

21. The system of claim 17, wherein the code is a change of address code.

22. The system of claim 17, wherein the code is a hold items code.

23. The system of claim 17, wherein the code is a forward items code.

24. The system of claim 17, wherein the information sheet contains the customer's old address.

25. The system of claim 17, wherein the information sheet contains the customer's new address.

26. The system of claim 17, wherein the information sheet contains information concerning the duration for which the customer's items be withheld from delivery.

27. The system of claim 17, wherein the information sheet contains information concerning potential hazards for delivery personnel.

28. A system for handling a customer request related to delivery of items, the system comprising:
means for receiving an item handling request from a customer;
means for processing the item handling request; and
means for generating an information sheet, including at least one code associated with the item handling request, wherein the code may be a change of address code, a hold items code, or a forward items code.

29. A computer-readable medium containing instructions for handling a customer request related to delivery of items, the instructions comprising:
receiving an item handling request from a customer;
processing the item handling request; and
generating an information sheet, including a code associated with the item handling request.
